(19) United States
(12) Patent Application Publication
(10) Pub. No.: US 2002/0165074 A1
(43) Pub. Date: Nov. 7, 2002

(54) Method for the operation of a roller

(76) Inventor: Karl-Heinz Kusters, Krefeld (DE)

Correspondence Address: KENYON & KENYON, ONE BROADWAY, NEW YORK, NY, 10004, US

(21) Appl. No.: 10/180,613

(22) Filed: Jun. 26, 2002

Related U.S. Application Data
(62) Division of application No. 09/449,696, filed on Nov. 24, 1999.

(30) Foreign Application Priority Data
Nov. 25, 1998 (DE) 198 54 339.5

(51) Int. Cl. D21G 1/02; B29C 43/46; B25F 5/02

(52) U.S. Cl. 492/7; 492/16

(57) ABSTRACT

For a roller mounted on roller bearings in a roller stand, a hydrostatic support element is provided directly next to the roller bearing. The support element applies an additional force sufficient to assure proper rolling movement of the roller bearing bodies of the roller bearing when there is insufficient weight on the roller bearing to assure proper rolling movement. Alternatively, when great force is applied to the roller, the support element can alleviate the force applied to the roller bearing.

### BACKGROUND OF THE INVENTION

The present invention relates to a roller for a calander. A calander roller typically has a roller journal at each end, and is rotatably mounted in a roller stand via roller bearings with roller bearing bodies.

The roller type of the present invention includes the usual types of rollers, such as deflection-controlled rollers with a hollow roller rotating around a crossbeam that does not rotate, or conventional rollers with a cylindrical roller body and roller journals. In normal operation, friction between the roller journals and the roller bearing bodies results in rolling movement of the roller bearing bodies. Operating circumstances can occur, however, in which the roller bearings are not subject to any noteworthy radial forces. The roller bearing bodies of the roller bearings then also are not subject to any contact force against the adjacent rolling contact surfaces of the roller bearing so that no friction can come about. The rolling contact surfaces then drag against the roller bearing bodies. This is an extremely disadvantageous operational state because it results in severe wear and rapid destruction of the roller bearings.

An example of such an undesirable operational state exists if the roller is the weighting roller of a calander stack, and no additional weighting forces are supposed to be applied via the roller bearings. In the case of a calander stack with a conventional top weighting roller, this operational state exists if the bottom roller presses the calander stack up with exactly the same force that corresponds to the weight of the top weighting roller. The weighting roller then rolls along without any force, as far as the forces which can be applied via the roller bearings are concerned. Such a case is not unusual, since the exertion of great line forces is not always an aim, depending on the purpose of treating the paper web or other web.

In order to counteract the loss of the friction contact between the roller bearing bodies and the rolling contact surfaces of the roller bearing rings, it is known from DE-GM 1 955 238 and DE-PS 932 942 to arrange elastic rings arranged in grooves in the rollers and/or the rolling contact surfaces. However, it is not advantageous for roller bearings because of the grooves and their edges, since these bearings must also be able to transfer very high radial stresses.

Affixing a device to exert force next to the roller bearing of a deflection-controlled roller is actually known from German Patent 30 03 396 C2. However, the goal in that patent is different, namely to influence the deflection line of the hollow roller of the deflection-controlled roller. To generate a sufficient deflection moment, a corresponding moment arm is required, i.e. the device to exert force must be arranged, as a function of its operation, at a certain axial distance from the roller bearing that forms the counter-bearing, if a noteworthy effect is to be achieved at a practicable size of the device to exert force.

### SUMMARY OF THE INVENTION

The object of the invention is to avoid undesirable operational states in which proper rolling movement of the roller bearing bodies does not occur.

This object is achieved, in its most general aspect, by providing a device adjacent to the roller bearing body which exerts force on the roller body.

With this device, a separate roller body weight can be artificially applied, so to speak, by activating the device to exert force on the roller bearings. The exerted force is just sufficient to ensure rolling movement of the roller bearing bodies. This force on the roller bearing bodies cannot be produced by a change in the roller weight, because the line force in the roll nip would be influenced, i.e. the change in line force necessary for this could not be utilized as line force in operation. In other words, a line force range that is not particularly narrow would be precluded from utilization for the rolling process. This limitation is avoided by the design according to the invention.

One feature of the present invention is that it can be used with either deflection controlled rollers or in conventional rollers.

An additional feature of the present invention is that the resulting force of the device can be in the plane of effect. In order to prevent dragging of the roller bearing bodies, it is not important in which direction the device to exert force acts, viewed in a plane perpendicular to the roller axis. If sufficient contact is guaranteed at only one point, the roller bearing body located there will be properly moved and will impart this movement also to the other roller bearing bodies, via the cage. Nevertheless, it is preferred if the resulting force of the device to exert force is located in the plane of effect.

Another feature of the present device to exert force is that it can be hydraulically activated in the preferred embodiment. Alternatively, it may have a hydrostatic support element, particularly one that acts radially against a rotating cylinder surface of the hollow roller or of the cross-beam, as is actually known from deflection-controlled rollers, for example from German Patent 22 30 139.

Another feature of the present invention is that the support element can be arranged, at the inside circumference of a ring housing connected with the roller stand, surrounding the roller journal, and then act against a cylinder surface of the roller journal.

An additional aspect of the present invention is that the device to exert force can include at least one pair of support elements of equal strength, arranged symmetrical to the plane of effect, whose resulting force is located in the plane of effect and which exerts a certain centering effect, in addition, onto the roller journal or the hollow roller.

An additional feature of the present invention is that the resulting force of the device can be located in the direction of the line force generated by the roller. Although the direction of the force resulting from the force exerted by the device to exert force primarily does not matter in preventing dragging of the roller bearing bodies, it can be advantageous in certain operational states. In the operational state in which the previously described situation of too little weight on the roller bearings does not exist, but rather the opposite is true, and there is great stress, the arrangement can serve to support the carrying function of the roller bearing. In other words, the device of the present invention can take over part of the stress on the bearing, so that the roller bearing can be made smaller for a specific high rated stress, or will have an extended lifetime.

### BRIEF DESCRIPTION OF THE DRAWINGS

An exemplary embodiment of a roller constructed according to the invention will be described in greater detail below by reference to the figures, in which:

FIG. 1 is a side view of the top part of a calander.

FIG. 2 is an enlarged partial sectional view of the radially inner part of the right top quadrant of the top roller in FIG. 1.

FIG. 3 is a longitudinal view, in lengthwise cross-section, taken along the line III-III in FIG. 2.

FIG. 4 is a partial sectional view of the end of a second embodiment of roller, for which the invention is implemented, partly in lengthwise cross-section.

### DETAILED DESCRIPTION OF THE DRAWINGS

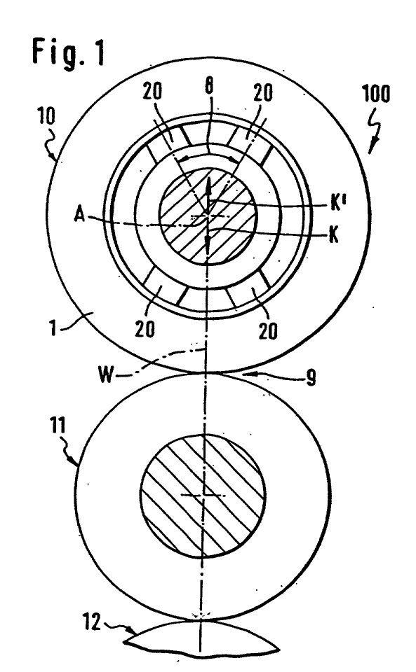

The calander 100 in FIG. 1 includes a vertical stack of rollers 10, 11, 12. Top roller 10 is a weighting roller of conventional design, mounted in a fixed manner in a roller stand, not shown, which therefore includes a cylindrical roller body 1 with coaxial roller journals 2 attached at the ends. The bottom roller of calander 100, not shown, is a deflection-controlled roller, which carries the entire roller stack and presses it up against weighting roller 10.

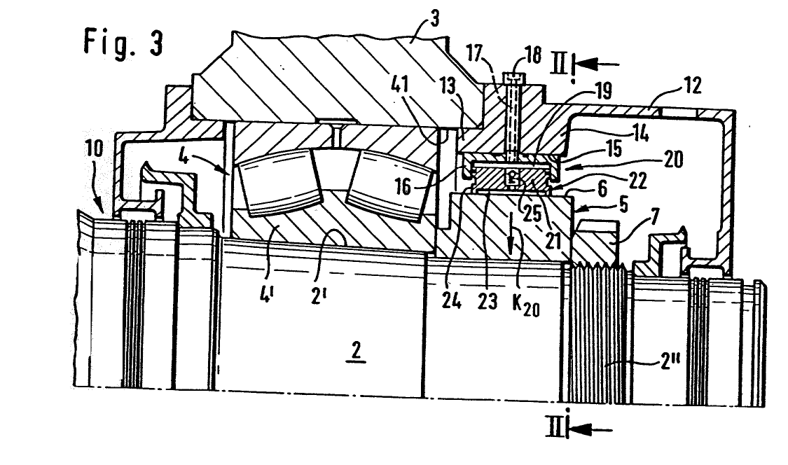

As shown in FIG. 3, roller 10 is mounted in roller stand 3, with its journals 2, via a roller bearing 4. Roller bearing 4 is arranged with its inner ring 4′ on a conical segment 2′ of roller journal 2. The diameter of conical segment 2′ increases towards the interior of the roller. On the outside of roller bearing 4, a support ring 5, with a cylindrical outside circumference surface 6, can be axially moved on roller journal 2. Support ring 5 can be pressed against inside ring 4′ of roller bearing 4 by a ring nut 7. Ring nut 7 is screwed onto a thread 2″ of roller journal 2, so that inside ring 4′ is pushed up onto conical segment 2′. This causes roller bearing 4 to be fastened in the axial direction, and allows adjustment of the radial play.

Support ring 5 is arranged axially directly next to roller bearing 4, outside of the latter in the exemplary embodiment. However, a corresponding axial ring could be provided within roller bearing 4, or support rings could be provided on both sides of it.

In the exemplary embodiment of FIGS. 1 to 3, four hydrostatic support elements 20 are provided. They lie diametrically opposite one another, in pairs, with reference to axis A, and are arranged symmetrical to the plane of effect W. The two support elements 20 provided above axis A and the two provided below axis A stand at an angle 8 of 60° relative to one another. Each support element acts against cylindrical outside circumference surface 6 of support ring 5. The resulting total force K of the two top support elements 20, 20 is directed downward, in accordance with FIG. 1, in the direction of roll nip 9 between rollers 10 and 11. The resulting force K′ of the two bottom support elements 20, is directed upward, away from roll nip 9.

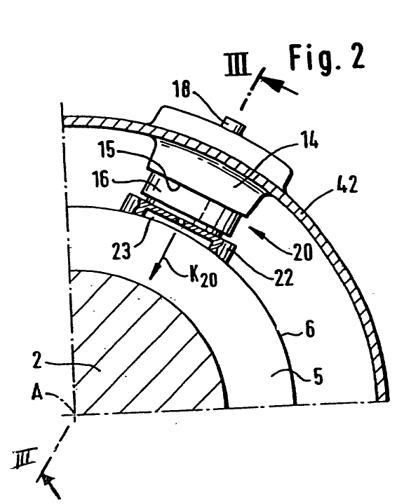

In FIG. 1, the support elements are only indicated schematically. Their structure is evident in detail in FIGS. 2 and 3. A ring housing 42 surrounding roller journal 2 engages into opening 41 of roller stand 3, with a collar 13, so that centering of ring housing 42 relative to roller stand 3 occurs. At the locations of support elements 20, ring housing 42 has projections 14 that project radially inward. Each projection forms a support surface 15 perpendicular to a radial ray passing through axis A. The radially outward surface of each support element 20 rests against support surface 15. Each support element 20 includes a cylinder part 16 which rests with its bottom against support surface 15. Cylinder part 16 is attached to projection 14 by a hollow-drilled screw 18. Hollow drilled screw 18 together with bore 17 forms a fluid feed line.

Piston part 21 of a slide shoe 22 engages into cylinder chamber 19 of cylinder part 16. Shoe 22 is shaped in accordance with cylinder surface 6, on the outside facing the cylinder surface, and there forms a bearing pocket 23. Bearing pocket 23 has an edge 24 which rests on cylinder surface 6 all around. Support surface 6 rotates under slide shoe 22, which is fixed in place. Pressurized fluid within bearing pocket 23 provides sufficient force to avoid any metal-on-metal friction in the region of bearing pocket 23. A film of fluid that constantly flows out between edge 24 and cylinder surface 6 avoids any metal on metal contact in the region of edge 24. Bearing pocket 23 is connected with cylinder chamber 19 via a connecting bore provided with a spring-loaded kick-back valve. When pressurized fluid is supplied via screw 18, bearing pocket 23 fills with pressurized fluid when the pressure produced by the spring force of the kick-back valve is exceeded. The pressurized fluid produces a corresponding force K₂₀ which is exerted on cylinder surface 6. The force K₂₀ is then transferred to roller journal 2.

Force K₂₀ can perform two functions. The first function is to artificially produce a weight, so to speak, if there is insufficient weight on roller bearing 4. For example, an operational state is possible in which the bottom roller of calander 100, not shown in FIG. 1, exerts a lifting force on the roller stack so that a line force prevails in roll nip 9 that precisely corresponds to the weight of top roller 10. In this operational state, there is no weight on roller bearing 4 and its roller bearing bodies would tend to be dragged along the rolling contact surface. Since calanders in the paper industry operate at high speeds, up to a range of 2000 m/min, such dragging would result in significant friction wear, both on the rolling contact surfaces and on the roller bearing bodies. Thus, such an operational state should be avoided, if at all possible. This can be done by exerting a force by means of support elements 20. The exerted force produces sufficient contact of the roller bearing bodies in roller bearing 4 to produce rolling movement, instead of a dragging movement.

The present invention can also be used to produce another support function in the more or less opposite case of weighting, namely if roller bearing 4 is not free of weight, but rather has to bear a particularly great force. This state can occur if the line force in roll nip 9 has to be increased beyond the inherent weight of top roller 10, by pressing the roller stack against it from below. A great radial stress in combination with the high speeds already mentioned represents the maximum stress for a roller bearing. If a resulting total force K is produced by support elements 20, which acts in the direction of roll nip 9, the arrangement of support elements 20 can relieve part of the stress on roller bearing 4. Therefore, roller bearing 4 can be sized smaller with regard to its maximum stress, or will have a longer lifetime.

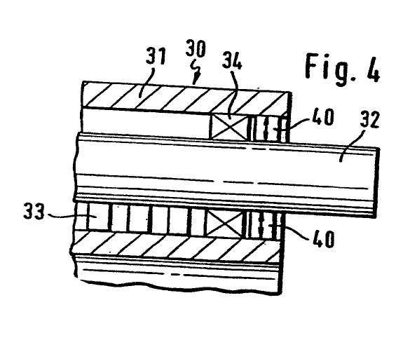

While roller 10 according to FIGS. 1 to 3 represents a conventional roller mounted in roller stand 3 in fixed manner, FIG. 4 indicates a deflection-controlled roller 30. In deflection-controlled toller 30, a hollow roller 31 rotates around a non-rotating cross-beam 32 which passes through it over its length. Cross-beam 32 is supported from the inside by a hydraulic support device 33, which is only schematically indicated, and acts against the inside circumference of hollow roller 31. Support elements 40 are provided for roller 30 and are located axially outside of roller bearings 34. Support elements 40 are attached in fixed manner on cross-beam 32, and act against the inside circumference of hollow roller 31 with their slide shoes. With regard to the arrangement in the circumferential direction and the structure, in detail, support elements 40 are similar to support elements 20. The two functions of maintaining a minimum weight on roller bearing 34 and support under very great stress can also be performed by support elements 40.

What is claimed is:

1. A roller for a calander comprising;
a cylindrical roller body which is rotatably mounted at both ends on roller bearings in a roller stand;
support devices adjacent to the roller bearings, the devices arranged so that they are on at least one side of the roller bearings when viewed in the axial direction; the devices engaging with the roller body on one side and with the roller stand on an opposite side, wherein the devices exert a force which runs radially and in the plane of effect.

2. The roller according to claim 1, wherein
the roller is a deflection-controlled roller with a rotatable hollow roller which forms the working roller circumference, further comprising:
a non-rotating cross-beam which passes through the hollow roller, over its length, leaving a space towards its inside circumference, which cross-beam is supported at the ends in outside supports, and on which the hollow roller is supported at its ends on the roller bearings, wherein the support device is arranged between the roller bearings in the interior of the hollow roller, the support device is supported on the cross-beam and acts against the inside circumference of the hollow roller to produce the line force to be exerted by the roller.

3. The roller according to claim 1, wherein the roller is a conventional roller with a cylindrical roller body that forms the working roller circumference, the roller has a concentric roller journal at each end, and the roller is rotatably mounted in the roller stand by means of roller bearings arranged on the roller journals.

4. The roller according to claim 1, wherein the support devices are hydraulically activated.

5. The roller according to claim 4, wherein at least one support device has at least one hydrostatic support element that acts radially against the inside circumference of the hollow roller.

6. The roller according to claim 4, wherein at least one support device has at least one hydrostatic support element that acts radially against the rotating cylinder surface of the roller.

7. The roller according to claim 1, wherein at least one support device is arranged on the inside circumference of a ring housing connected with the roller stand, and surrounding the roller journal.

8. The roller according to claim 1, wherein the support device generates a resulting force that acts in the direction of the line force.

9. The roller according to claim 2, wherein a support device includes at least one pair of support elements of equal strength, arranged symmetrical to the plane of effect.

10. An apparatus for reducing wear on roller bearings with roller bearing bodies, where the roller bearings rotatably support a roller for a calendar, comprising;
at least one support device; the support device located adjacent a roller bearing, the support device producing a controllable force,
wherein the controllable force is applied to a surface of the roller.
